(19) United States
(12) Patent Application Publication
(10) Pub. No.: US 2008/0006684 A1
(43) Pub. Date: Jan. 10, 2008

(54) Security Paper an Darticles Comprising Such Paper

(75) Inventor: Maarten Dirk-Johan Nollen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,579

(22) PCT Filed: Jul. 12, 2005
(86) PCT No.: PCT/IB05/52305

§ 371 Date: Jan. 3, 2007

(30) Foreign Application Priority Data
Jul. 13, 2004 (EP) 04103312.7

(51) Int. Cl. G06F 17/00

(52) U.S. Cl. 235/375

(57) ABSTRACT

The currency note (10) is provided with a first and a second integrated circuit (1,3), that each have an antenna (2,4). The antennas (2,4) preferably operate at different frequencies. Each of the integrated circuits (2,4) comprises a memory in which a chip code and a combination code are stored. The combination code has been programmed only after integration of the integrated circuits (2,4) into the currency note (10), and allows the recognition that the first integrated circuit (1) is part of the same currency note (10) as the second integrated circuit (3), when a plurality of currency notes (10) is read out at once, wirelessly.

The invention relates to a currency note comprising per unit a first chip and a second chip, each of which chips comprising a memory for storing information.

The invention further relates to a method of recognizing such currency notes.

An article of this kind is known from EP-A 905657. The article is a currency note, such as a banknote, check, stock or bond. In order to improve the identification and authentication of currency notes, this prior patent proposes incorporation of one or possibly more chips—also referred to as integrated circuits—in the currency note. The integration of more than one integrated circuit per banknote is, however, considered to be less advantageous due to the difficulty in establishing a large number of electric connections within a banknote.

The integrated circuit of the known banknote may be provided with a non-volatile memory that can be programmed only once, that is, by an irreversible physical action. An alternative choice would be to provide the integrated circuit with a non-volatile memory for storing identity information, and with a security circuit having a non-erasable memory (i.e. programmable only once), and being effective to inhibit programming of the non-volatile memory in relation to the contents of the non-erasable memory. If desired, the recording of information in the memory could be effected by a number of entities at different stages, each entity would typically enter information of its own province.

As is stated in the prior art patent, the cost argument is a problem for the integration of more than one integrated circuit in a single currency note.

It is therefore a first object of the invention to provide a currency note of the kind mentioned in the opening paragraph, which is provided with more than one integrated circuit in a cost-effective manner.

This object is achieved by the invention in that the stored information in each memory is provided with an identification code comprising a chip code and a combination code, which combination code identifies the first chip and the second chip being part of the same currency note. Furthermore, the first chip and the second chip are each provided with means for wireless communication with a reader.

The invention provides a solution without the need for electric connections within the currency note. At the same time, the first and second chips can be identified as belonging to one and the same currency note, even if not just one, but a pile of currency notes is read out wirelessly in one operation. In fact, the coupling of the first and second chips does not take place within the currency note, but through the reader and with the help of a combination code.

It is a first advantage of the invention that it will improve the security level of the currency notes. Abuse always uses the weakest link of a chain. The weakest link in the security of currency notes with integrated circuits appears to be neither the reverse engineering of the ICs, nor the number of possible memories. It appears to be the presence of chips meant for currency notes but still separated therefrom. Not only are such chips an easy target for burgling, but also are they present in large quantities and are many people involved in the manufacturing and design thereof. By using at least two chips, they can be ordered from different chip manufacturers. As a consequence, none of the employees of one chip manufacturer will have insight into the manufacturing, design and programming of both chips. As a consequence, it will reduce the risk that data become available through abuse or leakage of inside information.

It is a second advantage of the invention that it allows authorities in the field of currency notes to add information or select chips in a manner that can be kept completely hidden from the chip manufacturers. Those authorities cannot only define combination codes, but also select which chips are put together into a single currency note.

It is a third advantage of the invention that it can offer a first level identification of such currency notes without the need for getting access to a central database. The fact that both chips comprise a combination code that is entered by the relevant authority, allows that the combination code of the first chip is used as a reference code for the combination code of the second chip. This is advantageous in view of the time consumption for a security check in shops. It is also advantageous to limit the access to any reference database that evidently needs to be kept secret.

Several embodiments are possible for the combination codes. Most simply, the same code is used twice. In an advanced modification only a portion of the combination code is equal. The same code may moreover be split, so that other parts are interposed between subsequent parts of the code. The same code may moreover be present in a reverse order. In another version, the combination codes will add up to arrive at a hidden code, which may be any number. This could even be a number that has been added to the currency note already. Furthermore, on reading, the one combination code may give instructions how to read the other combination code, or even how to read the chip code.

In a further embodiment, the first and the second chip are different in a technological manner. This implies that a falsifier cannot just take two chips, but needs to have chips with the inherent technology, and hence needs to have access to the facilities of more than one chip manufacturer to make a currency note on its own. Such technological differences are of course relevant only as far as they are reflected in the identification code or in the manner in which such identification code is read. Options here are the size of a memory segment, the power needed for communication with the chip and also the power to be transferred in order to have an adequate operation, as well as the type of memory.

In a preferred embodiment, the memories of the first chip and of the second chip comprise a read-only segment and a programmable segment. The chip codes are programmed in the read-only segments, and the combination codes are programmed in the programmable segments. This physical implementation makes the chip code that is programmed by an chip manufacturer more difficult.

In a further embodiment, the first chip has means for wireless communication at another frequency than the second chip. The desire for reading out a pile of currency notes requires intelligent logistics for the read out of data. It appears efficient to address first all of the first chips and separately all of the second chips. The separation between the contact to the first chips and the second chips may be implemented on a software basis, e.g. by using different protocols. This appears rather difficult. A more elegant manner appears to be the use of different frequencies. Such frequencies need not differ very much. For clarity it is added that the determination of the order of the communication between integrated circuits and a reader is known per se, such as from U.S. Pat. No. 6,597,306.

Another practical problem relates to the manner of integrating at least two chips in a currency note. Chips in currency notes need to be flexible and need to be small in order to reduce the cost price. If the chips are assembled together, then the independency of the chip manufacturers reduces and a new place that is attractive for abuse will come into existence. In order to fulfill these requirements and to alleviate the problems, the currency note of the present invention comprises separate threads for the first chip and for the second chip. Metal threads are used in conventional banknotes as a security feature, and it has been proposed using these threads as a substrate and as an antenna for integrated circuits, particularly in WO-A 99/54842. Such threads are considered effective means for assembly. The flexible chips can be attached to such a thread first, and the thread can be rolled up thereafter for efficient transport. The integration of threads with security paper is moreover known per se. The effective integration of the integrated circuits with currency notes will then occur at the stage of the manufacture of the security paper only. This is however a stage that is linked to the authorities in the field of currency notes anyway, and in which security can be controlled more easily.

Within the context of this application, it is to be understood that the term ‘security paper’ includes both plastic and paper materials that are suitable for use in currency notes. This is a fiber-like high-quality material known per se to the skilled person in the art, which can adequately be provided with color prints.

Suitably, the integrated circuits are provided with an integrated antenna. This takes away the need for specific bonding operations at the assembly level, such as flip-chip bonding or even wirebonding. A suitable process for the manufacture of such integrated circuits is for instance described in the non-prepublished application EP 03102020.9 (PHNL030786). Alternatively, the antenna could be defined on the thread as stated before. In this example, the communication between antenna and integrated circuit may be achieved with a capacitive coupling instead of galvanic coupling.

The means for wireless communication with a reader generally include an antenna for transmission of data. Such antenna may be any conventional antenna such as a coil, a dipole antenna, and the like. Additionally, the means will include those parts of the circuit needed for adequate operation of received data, which may include an amplifier, filters, a processor for processing of the communication protocols. Such is known in the art of transponders, of which both active types and passive types exist and are known to the skilled person in the art. Alternatively, use could be made of an optical transmission between reader and chip. Another possibility is capacitive coupling; in this case the chip would be embedded in the currency note and provided with contacts. During the read out a capacitor is formed by the contacts of the chip and those of the reader, while the security paper has a dielectric. It will be understood that the different means may be present in addition to each other.

According to a further option, the antenna is suitable for reception and/or transmission of frequencies in different frequency bands. This principle is applied for mobile phones. In this example, the different frequency bands would not be used for communication over different distances, but for the provision of different accesses: a shop may be provided access to one frequency band only, with resulting limited access rights, whereas a bank office may have other access rights, relating for instance not only to reading but also to writing data into the programmable memory segment

It will be understood that the programmable segment of the memory may contain more data that the combination code only. It may even be used for the collection of data on the use of the specific currency notes, of for determination of validity and the like.

The chip codes and the combination codes may be encrypted according to desire and as known to the person skilled in the art.

It is a second object of the invention to provide a method of initializing a currency note comprising a first chip and a second chip. Each of these chips comprises a memory for storing information, which memory comprises a read-only segment and a programmable segment, which read-only segment is provided with a chip code, and is provided with means for wireless communication with the reader.

In order to initialize these currency notes, the method comprises the steps of reading the chip code in the first chip and providing a combination code in the programmable segment of the first chip; repeating the same for the second chip, and storing the chip codes and combination codes in a reference memory as reference codes for the currency note.

The result of the present method of initialization is the provision of currency notes according to the invention programmed with chip codes and combination codes, and secondly, the registration of these codes in a reference memory. This method can be carried out by the respective authorities in the field. Hence, it provides them with the necessary information that can be kept hidden from others.

It is a third object of the invention to provide a method of recognizing a plurality of currency notes as claimed in claim 1. This method comprises the steps of:

reading the combination codes in the memories of the first chips of the plurality of currency notes;

reading the combination codes in the memories of the second chips of the plurality of currency notes;

identifying the first chip and the second chip of a first banknote by comparison of the combination codes; and

recognizing a currency note of a first level on the basis of the combination codes.

According to the invention, both of the identification codes are read, and thereafter the first and second chips are identified as belonging to the same currency note via the comparison of the combination code. It is understood that the recognition may be carried out by comparison of the combination codes of the first and the second chip mutually. Alternatively, or additionally, use can be made of comparisons with the reference code in a reference memory. This first level identification can be very advanced, but also very basic, depending on the needs as to be found out in practice.

In order to provide a more extensive recognition, the following steps are carried out:

reading the chip codes of the first and second chips of the first currency note;

comparing the chip codes of the first and second chips of the first currency note with reference codes for this first currency note; and

recognizing the first currency note if said chip codes match the reference codes.

A full recognition process is carried out with this embodiment. This may be done for selected currency notes on the basis of a random or non-random choice. Parameters for a non-random choice may be denomination, age, rate of circulation and so on. If the full recognition process is carried out for all currency notes, it is preferred to read the chip codes in the same step as the combination codes are read.

It is observed that further data and codes may be present in the programmable segment of the memories that may be read, if needed. Writing of data into the programmable segment is not excluded, but is not deemed necessary.

These and other aspects of the currency note and the methods of the invention will be further elucidated with reference to the Figures, in which:

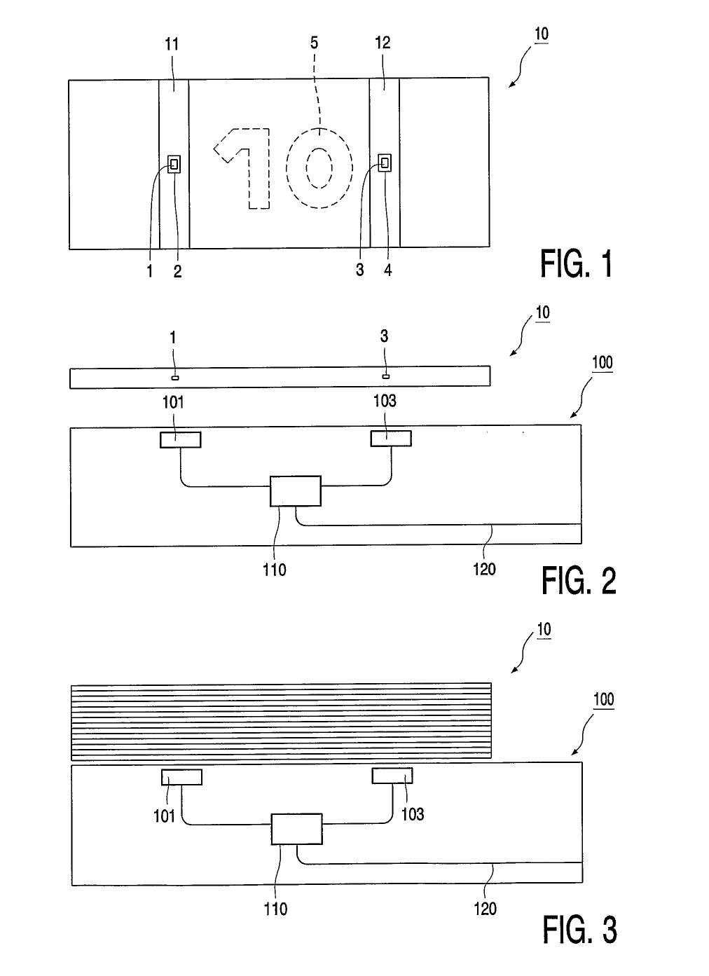

FIG. 1 diagrammatically shows a currency note;

FIG. 2 shows in cross-sectional view a currency note and a reader, and

FIG. 3 shows in cross-sectional view a plurality of currency notes present on a reader.

The Figures are not drawn to scale and like numbers refer to like parts.

FIG. 1 diagrammatically shows a currency note 10. It comprises a fiber-like material known in the art as security paper, on which a denomination 5 is printed. Additionally, the currency note 10 comprises a first integrated circuit 1 that is provided with an integrated antenna 2. The integrated circuit 1 is present on a thread 11. It is attached thereto with a suitable glue. The currency note 10 further comprises a second integrated circuit 2 that is provided with an antenna 4.

The integrated circuits 1,3 of this embodiment are manufactured on a silicon substrate, to which subsequently an interconnect structure, a polymer layer, for instance of polyimide, and then a temporary carrier are provided. The antenna is an inductor that is defined as part of the interconnect, but in principle in an area around the integrated circuit. Thereafter, the silicon substrate is removed largely, with the consequences, that the integrated circuit becomes flexible and that the antenna is supported by the polyimide layer instead of the silicon substrate. The resulting thickness is for instance in the order between 5 and 20 microns. The integrated circuit is present in a zone of the substrate that is not removed, for instance a mesa. If desired, bond pads may be defined on the side where the substrate used to be. Alternatively or additionally, this side may be provided with a second polyimide layer. The antenna 2 has a frequency of 2.5 GHz in this example, whereas the antenna 4 has a resonance frequency of 2.9 GHz. Most preferably, the integrated circuits 1, 3 are manufactured separately. For the return signal from the integrated circuit 1,3 to a reader, use can be made of a separate return antenna, which suitably operates at half the frequency of the main antenna. Because there are no substrate losses on the chip, the efficiency of these antennas is remarkably high and, consequently, the area of the antenna can be reduced to a few square millimeters. As will be understood, the exact frequency is a matter of straightforward design and can be chosen according to specification.

The first and the second integrated circuit 1,3 each have a memory. Part of the memory is a ROM memory type that has been programmed in the factory, before assembly of the individual integrated circuits to the threads. The information stored in this ROM memory is a chip code. The chip code is encrypted in a manner known per se to the person of skill in the art. Preferably, it has been stored separately in a database, but this is not necessary. Additionally, the integrated circuits 1,3 have a programmable memory segment. This programmable memory segment is programmed with a combination code during the initialization. The programmable memory segment is in this case a non-erasable, embedded type of memory.

FIG. 2 shows a cross-sectional view of a system comprising the currency note 10 with a first and a second integrated circuit 1,3, and further comprising a reader 100. The reader 100 is provided with first antenna means 101 and second antenna means 103. The first antenna 101 means are suitable for transmission of power and signals at a frequency of 2.5 GHz in this example, and for receiving signals at a frequency of 1.25. GHz. It is located opposite to the predefined position of the first integrated circuit. The second antenna means 103 are suitable for transmission of power and signals at a frequency of 2.9 GHz in this example, and for receiving signals at a frequency of 1.45 GHz. If desired, a single antenna suitable for different frequencies could be used, particularly if the integrated circuits 1,3 are positioned near to each other. However, on any occasion it is necessary to use separate amplifiers for the different frequencies and to provide adequate isolation between the amplified signal to be transmitted to the integrated circuit and the channel for the received signal that is still to be amplified. A single transceiver 110 will process all the signals, and be connected to an reference memory through connection 120. Readers for identification tags are known per se, for instance from U.S. Pat. No. 6,445,743.

FIG. 3 shows a cross-sectional view of a situation in which a reader 100 needs to identify a plurality of currency notes. In this situation, the first antenna means 101 will transmit information to the currency notes, and the first integrated circuits 1 (not shown) of which the antenna is suitable for reception of the transmitted signals, will react. The combination codes, and optionally the chip codes within the memories of these first integrated circuits 1, will be read consecutively and stored in a temporary memory of the reader 100. Thereafter, the second antenna means 103 will start to operate. After transmission of the signals and power the second integrated circuits 3 of the currency notes will react and send back the information in their memories, as far as requested. As the first and second integrated circuits are by no means mutually interconnected, it has to be found out which first and second integrated circuits 1,3 are part of the same currency note. This is achieved with the help of the combination code.

In short, the currency note 10 of the invention is provided with a first and a second integrated circuit 1,3, which each has an antenna 2,4. The antennas 2,4 preferably operate at different frequencies. Each of the integrated circuits 2,4 comprises a memory in which a chip code and a combination code are stored. The combination code has been programmed only after integration of the integrated circuits 2,4 with the currency note 10, and allows the recognition that the first integrated circuit 1 is part of the same currency note 10 as the second integrated circuit 3, when a plurality of currency notes 10 is read out at once, wirelessly.

1. Currency note comprising a first chip and a second chip and means for wireless communication with a reader, each of which chips comprising a memory for storing information, wherein:
the stored information in each memory is provided with an identification code comprising a chip code and a combination code, which combination code identifies the first chip and the second chip being part of the same currency note, and
the first chip and the second chip are each provided with means for wireless communication with the reader.

2. Currency note as claimed in claim 1, wherein:
the memories of the first chip and of the second chip comprise a read-only segment and a programmable segment,
the chip codes are programmed in the read-only segments, and
the combination codes are programmed in the programmable segments.

3. Currency note as claimed in claim 1, wherein the first chip has means for wireless communication at another frequency than the second chip.

4. Currency note as claimed in claim 1, wherein the first and the second chip are provided on separate threads.

5. Currency note as claimed in claim 4, wherein one of the threads is a metal thread.

6. A method of initializing a currency note comprising a first chip and a second chip, wherein each of which chips:
comprises a memory for storing information that comprises a read-only segment and a programmable segment, which read-only segment is provided with a chip code, and
is provided with means for wireless communication with the reader,
which method comprises the steps of:
reading the chip code in the first chip;
providing a combination code in the programmable segment of the first chip;
reading the chip code in the second chip;
providing a combination code in the programmable segment of the second chip, and
storing the chip codes and combination codes in a reference memory as reference codes for the currency note.

7. A method of recognizing a plurality of currency notes as claimed in claim 1, comprising the steps of:
reading the code in the memories of the first chips of the plurality of currency notes;
reading the code in the memories of the second chips of the plurality of currency notes;
identifying the first chip and the second chip of a first banknote by comparison of the combination codes, and
recognizing a currency note of a first level on the basis of the combination codes.

8. A method as claimed in claim 7, comprising the further steps of:
reading the chip codes of the first and second chips of the first currency note;
comparing the chip codes of the first and second chips of the first currency note with reference codes for this first currency note; and
recognizing the first currency note if said chip codes match the reference codes.
